(19) United States
(12) Patent Application Publication
(10) Pub. No.: US 2025/0069834 A1
(43) Pub. Date: Feb. 27, 2025

(54) CONTACTOR MOVABLE TERMINAL ASSEMBLY AND CONTACTOR

(71) Applicants: Tyco Electronics (Shanghai) Co., Ltd., Shanghai (CN); TE Connectivity Austria GmbH, Waidhofen an der Thaya (AT)

(72) Inventors: Xiaoning Zhang, Shenzhen (CN); Hailin (Timothy) Chen, Shenzhen (CN); Markus Gutmann, Waidhofen an der Thaya (AT)

(73) Assignees: Tyco Electronics (Shanghai) Co., Ltd., Shanghai (CN); TE Connectivity Austria GmbH, Waidhofen an der Thaya (AT)

(21) Appl. No.: 18/811,944

(22) Filed: Aug. 22, 2024

(30) Foreign Application Priority Data
Aug. 22, 2023 (CN) 202311062152.X

(51) Int. Cl. H01H 50/18; H01H 50/54

(52) U.S. Cl. CPC H01H 50/18; H01H 50/54

(57) ABSTRACT

A contactor movable terminal assembly includes a movable terminal, a driving shaft movably connected to the movable terminal, a main elastic member axially compressed between a bottom of the movable terminal and the driving shaft to provide a main contact pressure to the movable terminal, and an auxiliary elastic member disposed between the movable terminal and the driving shaft. The driving shaft drives the movable terminal from an opened position electrically separated from a static terminal to a closed position electrically in contact with the static terminal. The auxiliary elastic member is axially compressed between the bottom of the movable terminal and the driving shaft to provide an auxiliary contact pressure to the movable terminal when the movable terminal is in the closed position. The auxiliary elastic member is not axially compressed when the movable terminal is in the opened position.

### CROSS-REFERENCE TO RELATED APPLICATION

This application claims the benefit of the filing date under 35 U.S.C. § 119 (a)-(d) of Chinese Patent Application No. 202311062152.X, filed on Aug. 22, 2023.

### FIELD OF THE INVENTION

The present invention relates to a contactor movable terminal assembly and a contactor comprising the contactor movable terminal assembly.

### BACKGROUND OF THE INVENTION

The ability to withstand short-circuit current is an important performance indicator of DC contactors. When the short-circuit current flows through the movable and static terminals of the contactor, an electric repulsion force will be generated between the movable and static terminals. If the contact pressure between the closed movable and static terminals is insufficient to resist this electric repulsion, the movable and static terminals will separate and generate a strong arc, which may ultimately cause safety accidents.

To increase the ability to withstand short circuit current, some manufacturers take advantage of the characteristic that when short circuit current passes through the movable terminal of contactor, a magnetic field is generated around the movable terminal. They add ferromagnetic components that surround the movable terminal. The direction of electromagnetic attraction generated by these ferromagnetic components is opposite to the direction of electric repulsion generated by short circuit current on the movable terminal, offsetting some of the electric repulsion to improve the ability of contactor to withstand short circuit current. However, the existing anti short-circuit current scheme has problems such as a complex structure, difficult installation, and high cost.

### SUMMARY OF THE INVENTION

A contactor movable terminal assembly includes a movable terminal, a driving shaft movably connected to the movable terminal, a main elastic member axially compressed between a bottom of the movable terminal and the driving shaft to provide a main contact pressure to the movable terminal, and an auxiliary elastic member disposed between the movable terminal and the driving shaft. The driving shaft drives the movable terminal from an opened position electrically separated from a static terminal to a closed position electrically in contact with the static terminal. The auxiliary elastic member is axially compressed between the bottom of the movable terminal and the driving shaft to provide an auxiliary contact pressure to the movable terminal when the movable terminal is in the closed position. The auxiliary elastic member is not axially compressed when the movable terminal is in the opened position.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a contactor movable terminal assembly according to a first embodiment of the present invention;

FIG. 2 shows an axial sectional view of the contactor movable terminal assembly according to the first embodiment of the present invention, wherein the movable terminal is in an opened position electrically separated from the static terminal;

FIG. 3 shows an axial sectional view of the contactor movable terminal assembly according to the first embodiment of the present invention, wherein the movable terminal is in a closed position in electrical contact with the static terminal;

FIG. 4 shows an axial sectional view of the contactor movable terminal assembly according to a second embodiment of the present invention, wherein the movable terminal is in an opened position electrically separated from the static terminal;

FIG. 5 shows an axial sectional view of the contactor movable terminal assembly according to the second embodiment of the present invention, wherein the movable terminal is in a closed position in electrical contact with the static terminal;

FIG. 6 shows an illustrative perspective view of the auxiliary clastic member of the contactor movable terminal assembly according to the second embodiment of the present invention;

FIG. 7 shows an axial sectional view of the contactor movable terminal assembly according to a third embodiment of the present invention, wherein the movable terminal is in an opened position electrically separated from the static terminal;

FIG. 8 shows an axial sectional view of the contactor movable terminal assembly according to the third embodiment of the present invention, wherein the movable terminal is in a closed position in electrical contact with the static terminal;

FIG. 9 shows an axial sectional view of the contactor movable terminal assembly according to the fourth embodiment of the present invention, wherein the movable terminal is in an opened position electrically separated from the static terminal;

FIG. 10 shows an axial sectional view of the contactor movable terminal assembly according to a fourth embodiment of the present invention, wherein the movable terminal is in a closed position in electrical contact with the static terminal; and

FIG. 11 shows an illustrative perspective view of the auxiliary elastic member of the contactor movable terminal assembly according to the fourth embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

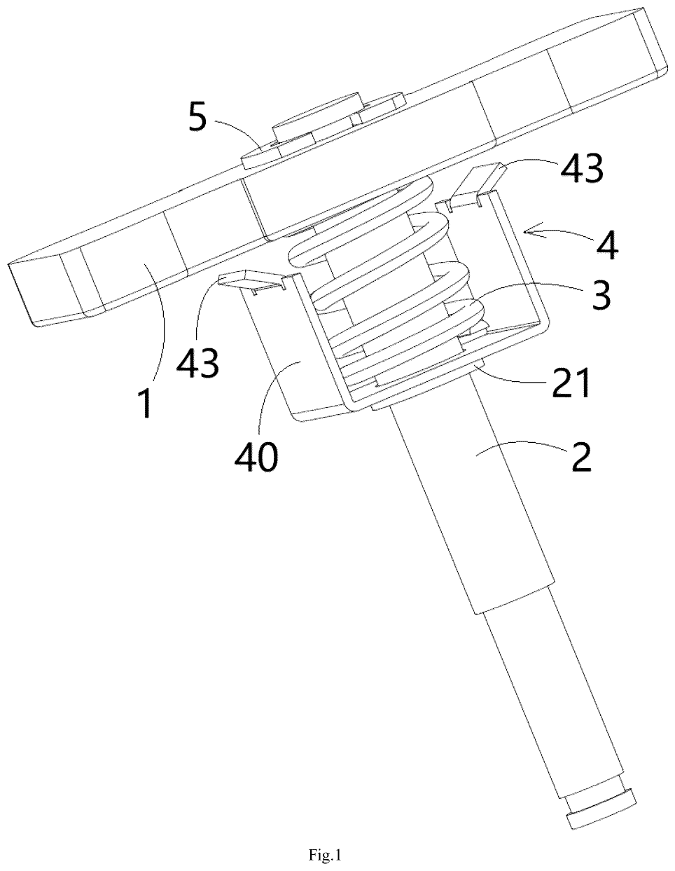

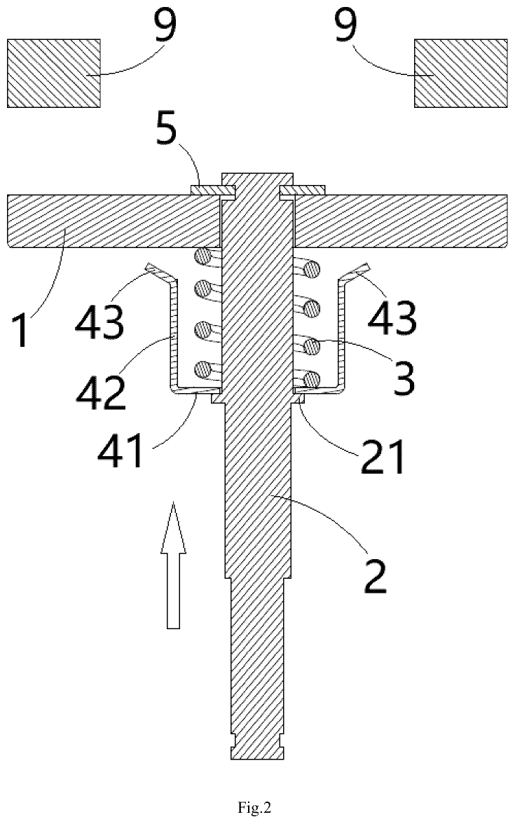

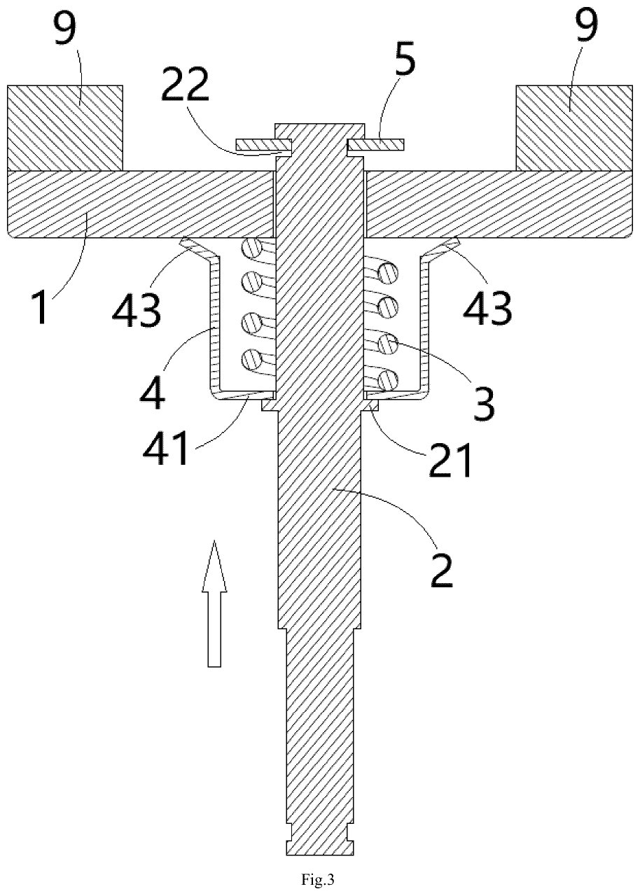

FIGS. 1-3 show a contactor movable terminal assembly according to a first embodiment of the present invention. The contactor movable terminal assembly includes a movable terminal 1, a driving shaft 2, a main elastic member 3, and an auxiliary elastic member 4. The driving shaft 2 is movably connected to the movable terminal 1, and is used to drive the movable terminal 1 from an opened position electrically separated from a static terminal 9, shown in FIG. 2, to a closed position electrically in contact with the static terminal 9, shown in FIG. 3. The main elastic member 3 is axially compressed between a bottom of the movable terminal 1 and the driving shaft 2 for providing the main contact pressure to the movable terminal 1. The auxiliary elastic member 4 is set between the movable terminal 1 and the driving shaft 2.

As shown in FIG. 3, in the illustrated embodiment, when the movable terminal 1 is in the closed position, the auxiliary elastic member 4 is axially compressed between the bottom of the movable terminal 1 and the driving shaft 2 for providing auxiliary contact pressure to the movable terminal 1. As shown in FIG. 2, when the movable terminal 1 is in the opened position, the auxiliary elastic member 4 is not axially compressed and does not come into contact with the movable terminal 1.

As shown in FIGS. 1-3, in the illustrated embodiments, a radial protruding flange portion 21 is formed on the driving shaft 2, the auxiliary elastic member 4 is axially supported on the flange portion 21, and the main elastic member 3 is axially compressed between the bottom of the movable terminal 1 and the flange portion 21 of the driving shaft 2.

In the illustrated embodiment, the main elastic member 3 can be a helical spring.

As shown in FIGS. 1-3, the auxiliary elastic member 4 includes a main body 40 and a cantilever portion 43. The cantilever portion 43 is connected to the main body 40. The main body 40 is axially supported on the flange portion 21, and the two ends of the main elastic member 3 are respectively pressed against the main body 40 and the movable terminal 1. When the movable terminal 1 is in the closed position, the end of the cantilever portion 43 is pressed against the bottom of the movable terminal 1.

As shown in FIGS. 1-3, in the illustrated embodiments, the main body 40 comprises a bottom wall 41 and a side wall 42 connected to the bottom wall 41. The cantilever portion 43 is connected to an upper edge of the side wall 42 and extends obliquely relative to the side wall 42. The bottom wall 41 of the main body 40 abuts against the flange portion 21 of the driving shaft 2, and the lower end of the main elastic member 3 is against the bottom wall 41 of the main body 40.

As shown in FIGS. 1-3, in the illustrated embodiments, the upper end of the driving shaft 2 is movably passed through the movable terminal 1, and a limiting member 5 is installed on the upper end of the driving shaft 2. When the movable terminal 1 is in the opened position, the limiting member 5 is axially pressed against the top of the movable terminal 1 to limit the position of the movable terminal 1. When the movable terminal 1 is in the closed position, the limiting member 5 is separated from the movable terminal 1 by a predetermined distance.

As shown in FIG. 3, in the illustrated embodiments, a snap slot 22 is formed on the outer peripheral surface of the upper end of the driving shaft 2, and the limiting member 5 is a snap ring. The snap ring is fitted in the snap slot 22 of the driving shaft 2.

In another exemplary embodiment of the present invention, a contactor is also disclosed. The contactor includes: a housing, the static terminal 9, a coil, and the aforementioned contactor movable terminal assembly. The static terminal 9 is fixed into the housing. The coil is installed in the housing. The contactor movable terminal assembly is movably installed in the housing. When the coil is energized, the driving shaft 2 drives the movable terminal 1 from the open position to the closed position under the electromagnetic force generated by the coil.

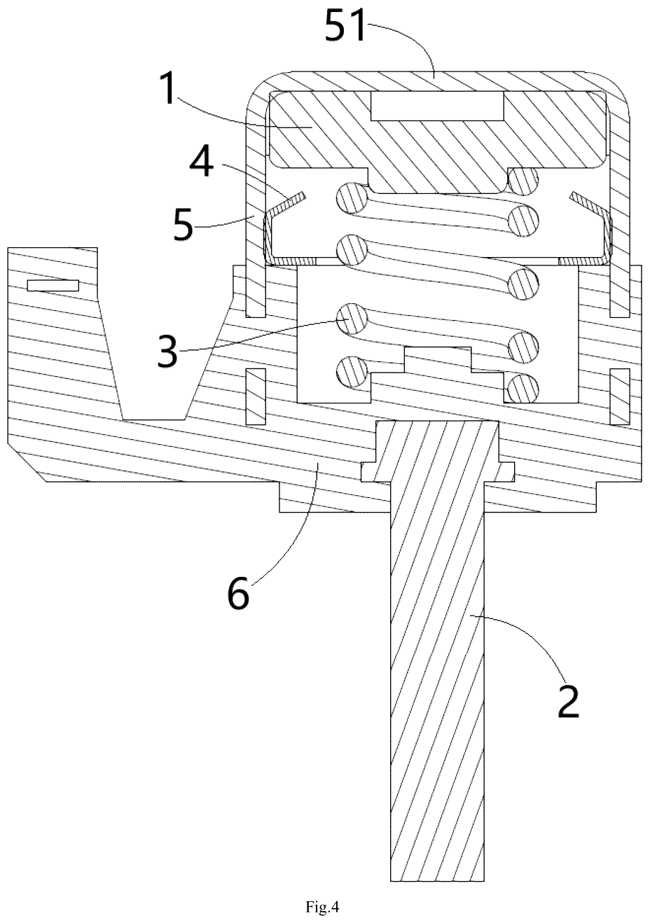

FIGS. 4-6 show the contactor movable terminal assembly according to a second embodiment of the present invention. The contactor movable terminal assembly includes: a movable terminal 1, a driving shaft 2, a main elastic member 3, and an auxiliary elastic member 4. The driving shaft 2 is movably connected to the movable terminal 1, used to drive the aforementioned movable terminal 1 from an opened position electrically separated from the static terminal 9 to a closed position electrically in contact with the static terminal 9. The main elastic member 3 is axially compressed between the bottom of the movable terminal 1 and the driving shaft 2 for providing the main contact pressure to the movable terminal 1. The auxiliary elastic member 4 is set between the movable terminal 1 and the driving shaft 2.

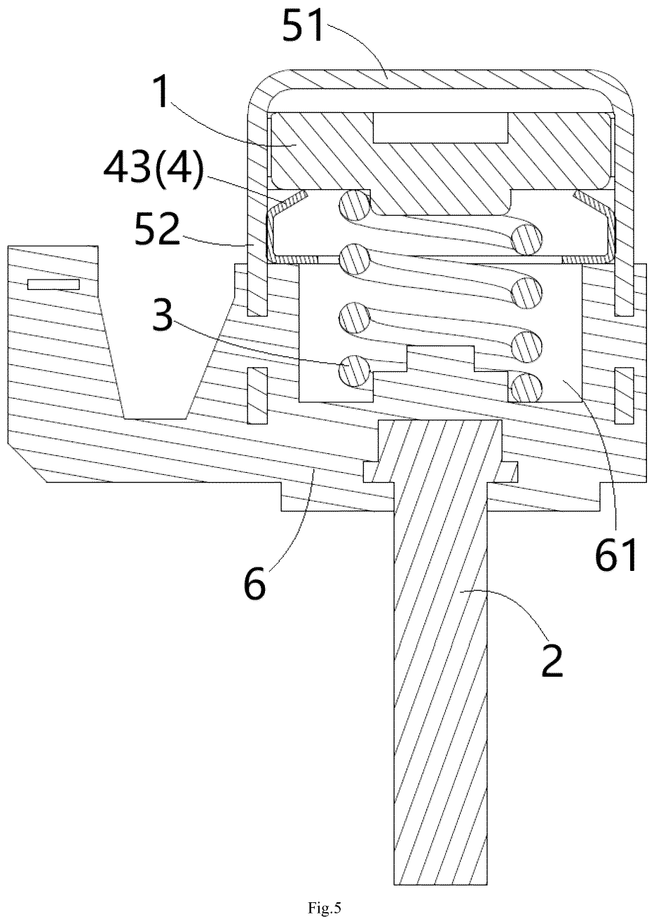

As shown in FIGS. 4-6, in the illustrated embodiments, the contactor movable terminal assembly further comprises an insulator 6. The upper end of driving shaft 2 is fixed in insulator 6. The main elastic member 3 is axially compressed between the movable terminal 1 and the insulator 6, while the auxiliary elastic member 4 is axially supported on the insulator 6. As shown in FIG. 5, when the movable terminal 1 is in the closed position, the auxiliary elastic member 4 is axially compressed between the movable terminal 1 and the insulator 6.

In the embodiment shown in FIGS. 4-6, the main elastic member 3 can be a helical spring.

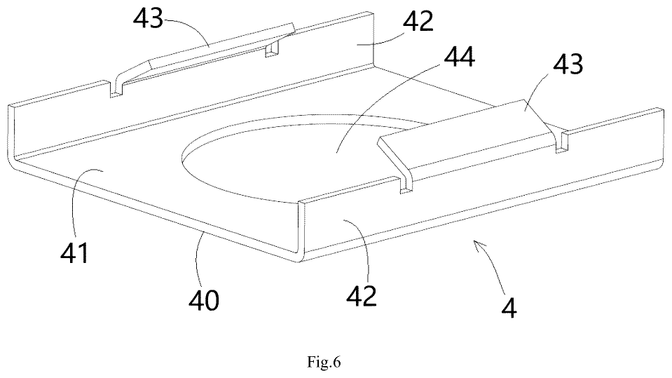

The auxiliary elastic member 4, as shown in FIG. 6, includes a main body 40 and a cantilever portion 43. The cantilever portion 43 is connected to the main body 40. The main body 40 is axially supported on the insulator 6, and the two ends of the main elastic member 3 are pressed against the movable terminal 1 and the insulator 6, respectively. When the movable terminal 1 is in the closed position, the end of the cantilever portion 43 is pressed against the bottom of the movable terminal 1.

As shown in FIGS. 4-6, the main body 40 comprises a bottom wall 41 supported on the top surface of the insulator 6 and a side wall 42 connected to the bottom wall 41. The cantilever portion 43 is connected to the upper edge of the side wall 42 and extends obliquely relative to the side wall 42.

As shown in FIGS. 4 to 6, in the illustrated embodiments, an opening 44 is formed in the bottom wall 41 of the main body 40 that allows the main elastic member 3 to pass through, and a recess 61 is formed on the top of the insulator 6 to accommodate the main clastic member 3. The main elastic member 3 passes through the bottom wall 41 of the main body 40, and the lower end of the main clastic member 3 is supported on the bottom surface of the recess 61 of the insulator 6.

As shown in FIGS. 4-6, in the illustrated embodiments, the contactor movable terminal assembly further comprises a limiting member 5, which comprises a top plate 51 and a pair of side plates 52. The pair of side plates 52 are connected to the top plate 51. The lower parts of the pair of side plates 52 of the limiting member 5 are fixed to the insulator 6, and the movable terminal 1 and the auxiliary clastic member 4 are accommodated in the limiting member 5. As shown in FIG. 4, when the movable terminal 1 is in the opened position, the top plate 51 of the limiting member 5 is axially pressed against the top of the movable terminal 1 to limit the position of the movable terminal 1. As shown in FIG. 5, when the movable terminal 1 is in the closed position, the top plate 51 of the limiting member 5 is separated from the movable terminal 1 by a predetermined distance.

In the embodiment shown in FIGS. 4-6, the insulator 6 is an injection molded part directly formed on the driving shaft 2 and the limiting member 5 through an embedded injection molding process, so that the driving shaft 2, the limiting member 5, and the insulator 6 are formed into an integral piece.

In another exemplary embodiment of the present invention, a contactor is also disclosed. The contactor includes: a housing, a static terminal 9, a coil, and the aforementioned contactor movable terminal assembly. The static terminal 9 is fixed into the housing. The coil is installed in the housing. The contactor movable terminal assembly is movably installed in the housing. When the coil is energized, the driving shaft 2 drives the movable terminal 1 from the open position to the closed position under the electromagnetic force generated by the coil.

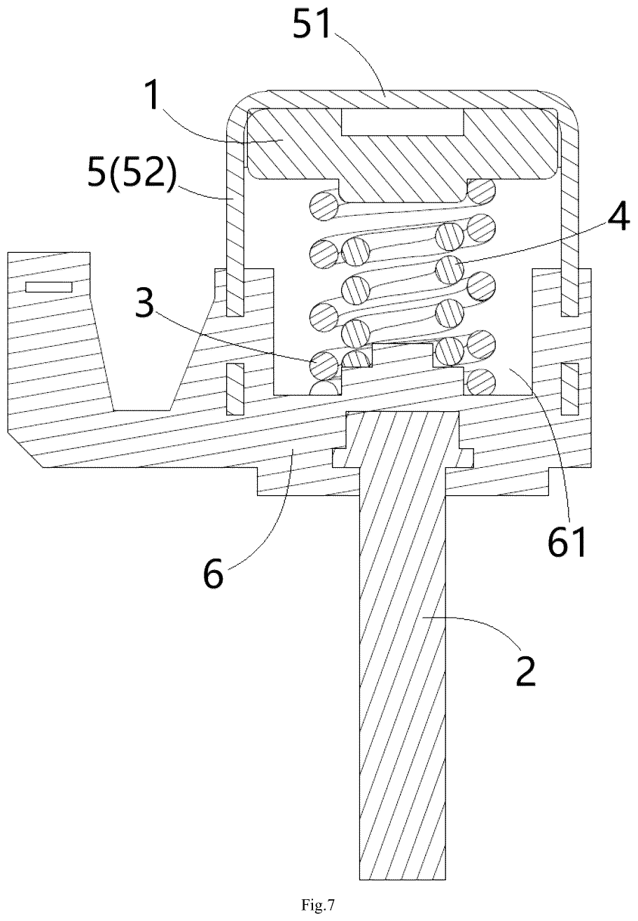

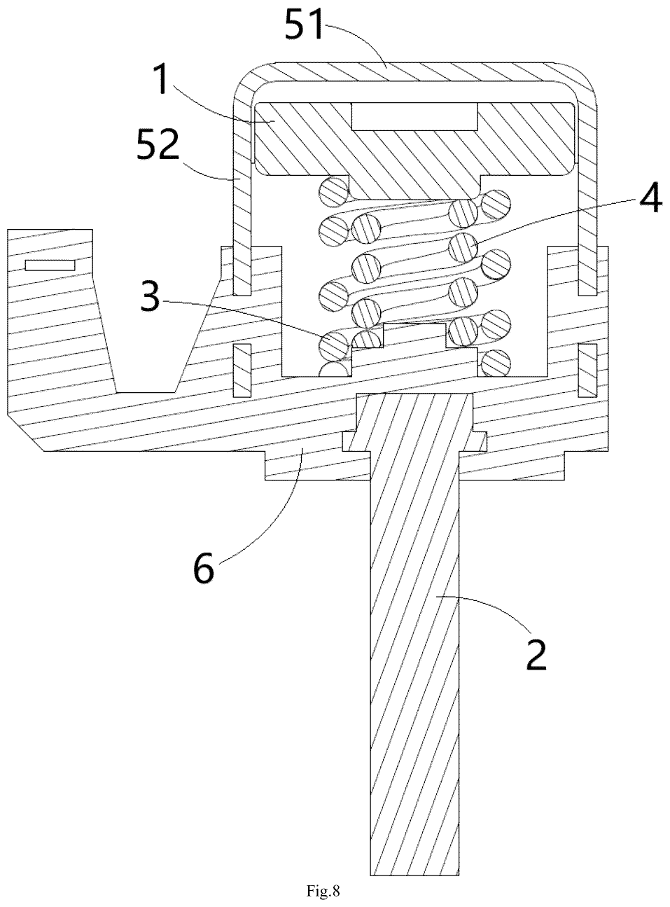

FIGS. 7-8 show a contactor movable terminal assembly according to the third embodiment of the present invention. The contactor movable terminal assembly includes a movable terminal 1, a driving shaft 2, a main clastic member 3, and an auxiliary elastic member 4. The driving shaft 2 is movably connected to the movable terminal 1, used to drive the aforementioned movable terminal 1 from an opened position electrically separated from the static terminal 9 to a closed position electrically in contact with the static terminal 9. The main clastic member 3 is axially compressed between the bottom of the movable terminal 1 and the driving shaft 2, to provide the main contact pressure to the movable terminal 1. The auxiliary clastic member 4 is set between the movable terminal 1 and the driving shaft 2.

As shown in FIGS. 7 and 8, in the illustrated embodiments, the contactor movable terminal assembly further comprises an insulator 6. The upper end of driving shaft 2 is fixed in the insulator 6. The main clastic member 3 is axially compressed between the movable terminal 1 and the insulator 6, while the auxiliary clastic member 4 is axially supported on the insulator 6. As shown in FIG. 8, when the movable terminal 1 is in the closed position, the auxiliary elastic member 4 is axially compressed between the movable terminal 1 and the insulator 6.

As shown in FIGS. 7 and 8, in the illustrated embodiments, the main clastic member 3 and the auxiliary elastic member 4 are spiral springs, respectively. The auxiliary elastic member 4 is set inside the main elastic member 3. A recess 61 is formed on the top of the insulator 6 to accommodate the main clastic member 3 and the auxiliary elastic member 4. The lower end of the main clastic member 3 is supported on the bottom surface of the recess 61 of the insulator 6, and the auxiliary clastic member 4 is received in the space between the movable terminal 1 and the bottom surface of the recess 61 of the insulator 6.

As shown in FIGS. 7 and 8, in the illustrated embodiments, the contactor movable terminal assembly further comprises a limiting member 5, which comprises a top plate 51 and a pair of side plates 52. The pair of side plates 52 are connected to the top plate 51. The lower parts of the pair of side plates 52 of the limiting member 5 are fixed to the insulator 6, and the movable terminal 1 is accommodated in the limiting member 5. As shown in FIG. 7, when the movable terminal 1 is in the opened position, the top plate 51 of the limiting member 5 is axially pressed against the top of the movable terminal 1 to limit the position of the movable terminal 1. As shown in FIG. 8, when the movable terminal 1 is in the closed position, the top plate 51 of the limiting member 5 is separated from the movable terminal 1 by a predetermined distance.

In the embodiment shown in FIGS. 7 and 8, the insulator 6 is an injection molded part directly molded onto the driving shaft 2 and the limiting member 5 through embedded injection molding process, so that the driving shaft 2, the limiting member 5, and the insulator 6 are formed into an integral piece.

In another exemplary embodiment of the present invention, a contactor is also disclosed. The contactor includes a housing, a static terminal 9, a coil, and the aforementioned contactor movable terminal assembly. The static terminal 9 is fixed into the housing. The coil is installed in the housing. The contactor movable terminal assembly is movably installed in the housing. When the coil is energized, the driving shaft 2 drives the movable terminal 1 from the open position to the closed position under the electromagnetic force generated by the coil.

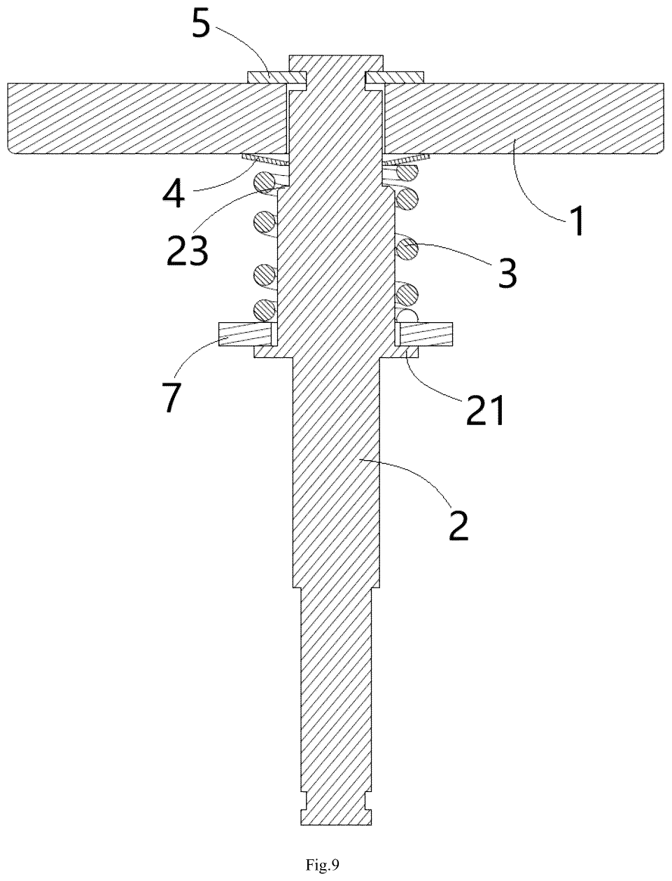

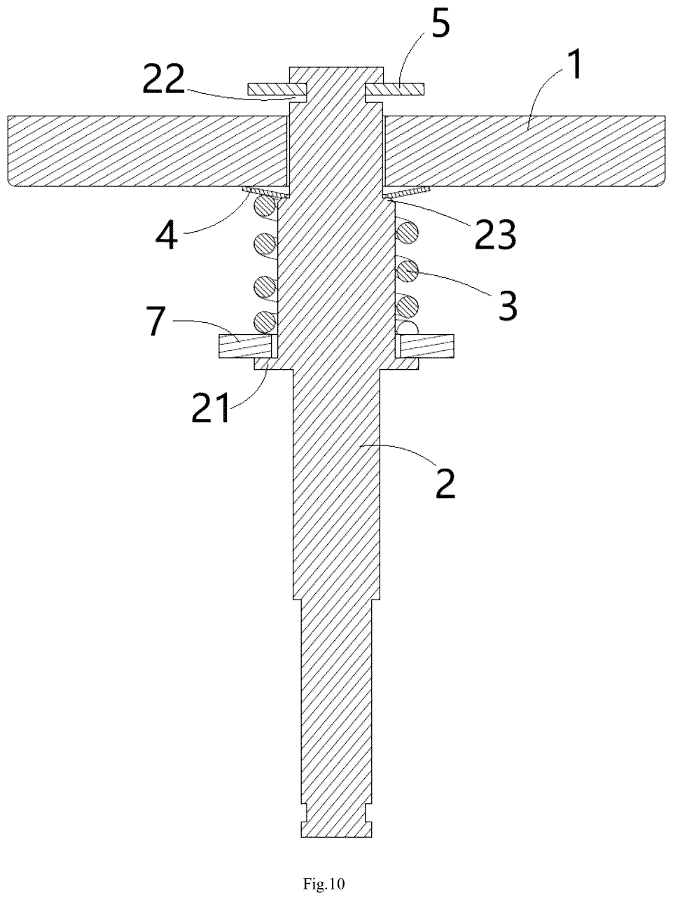

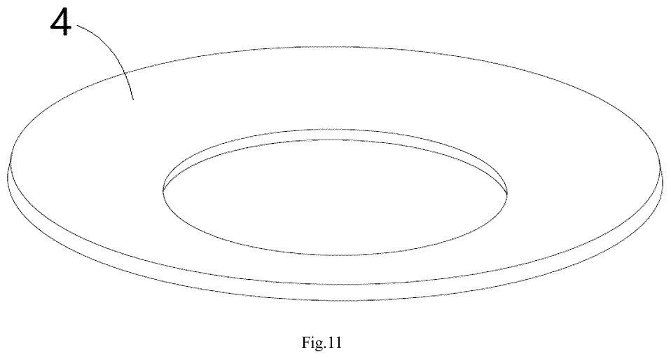

FIGS. 9-11 show the contactor movable terminal assembly according to the fourth embodiment of the present invention. The contactor movable terminal assembly includes a movable terminal 1, a driving shaft 2, a main elastic member 3, and an auxiliary elastic member 4. The driving shaft 2 is movably connected to the movable terminal 1, used to drive the aforementioned movable terminal 1 from an opened position electrically separated from the static terminal 9 to a closed position electrically in contact with the static terminal 9. The main elastic member 3 is axially compressed between the movable terminal 1 and the driving shaft 2 to provide the main contact pressure to the movable terminal 1. The auxiliary elastic member 4 can be kept between the bottom of the movable terminal 1 and a shoulder 23 of the driving shaft 2, or between the bottom of the movable terminal 1 and the top of the main elastic member 3. As shown in FIG. 10, when the movable terminal 1 is in the closed position, the auxiliary elastic member 4 is axially compressed between the bottom of the movable terminal 1 and the driving shaft 2 to provide auxiliary contact pressure to the movable terminal 1.

As shown in FIGS. 9 and 10, in the illustrated embodiment, the shoulder 23 is formed on the driving shaft 2, which is suitable for pressing against the bottom of the auxiliary elastic member 4. As shown in FIG. 10, when the movable terminal 1 is in the closed position, the auxiliary elastic member 4 is axially compressed between the bottom of the movable terminal 1 and the shoulder 23 of the driving shaft 2. As shown in FIG. 9, when the movable terminal 1 is in the opened position, the auxiliary elastic member 4 does not contact the shoulder 23 of the driving shaft 2 and is spaced from it by a predetermined distance in the axial direction.

As shown in FIGS. 9 and 10, in the illustrated embodiment, the main elastic member 3 is a spiral spring and the auxiliary elastic member 4 is a disc spring. The auxiliary elastic member 4 has a bottom opening and a top opening, and the diameter of the top opening is larger than that of the bottom opening. The edge of the top opening of the auxiliary elastic member 4 is against the bottom surface of the movable terminal 1, and the bottom of the auxiliary elastic member 4 is against the top of the main elastic member 3 or the shoulder 23 of the driving shaft 2.

As shown in FIGS. 9 and 10, in the illustrated embodiments, a radially protruding flange portion 21 is formed on the driving shaft 2, and the main elastic member 3 is axially compressed between the bottom of the auxiliary clastic member 4 or the movable terminal 1 and the flange portion 21 of the driving shaft 2.

In the embodiment shown in FIGS. 9 and 10, the contactor movable terminal assembly further comprises a washer 7, which is supported on the flange portion 21 of the driving shaft 2 and has a diameter larger than that of the flange portion 21. The upper and lower ends of the main clastic member 3 are respectively pressed against the bottom of the auxiliary elastic member 4 and the top surface of the washer 7, or against the bottom of the movable terminal 1 and the top surface of the washer 7.

As shown in FIGS. 9 and 10, in the illustrated embodiment, the upper end of the driving shaft 2 is movably passed through the movable terminal 1, and a limiting member 5 is installed on the upper end of the driving shaft 2. When the movable terminal 1 is in the opened position, the limiting member 5 is axially pressed against the top of the movable terminal 1 to limit the position of the movable terminal 1. When the movable terminal 1 is in the closed position, the limiting member 5 is separated from the movable terminal 1 by a predetermined distance.

As shown in FIG. 10, a snap slot 22 is formed on the outer peripheral surface of the upper end of the driving shaft 2, and the limiting member 5 is a snap ring. The snap ring is fitted in the snap slot 22 of the driving shaft 2.

In an embodiment, the elastic coefficient of the auxiliary elastic member 4 is greater than that of the main clastic member 3, so that under the same axial pressure, the axial compression amount of the auxiliary clastic member 4 is smaller than that of the main elastic member 3. Therefore, as shown in FIG. 9, when the movable terminal 1 is in the opened position, the axial compression amount of the auxiliary elastic member 4 is very small and can be almost ignored.

Please note that the present invention is not limited to the embodiments shown in FIGS. 9-11. For example, when the size of the main clastic member 3 is large, the auxiliary elastic member 4 can be located inside the main elastic member 3 and not in contact with the main elastic member 3. In this case, the auxiliary elastic member 4 is supported on the shoulder 23 of the driving shaft 2, and the main elastic member 3 is axially compressed between the bottom of the movable terminal 1 and the flange portion 21 of the driving shaft 2. When the movable terminal 1 is in the closed position, the auxiliary elastic member 4 is axially compressed between the bottom of the movable terminal 1 and the shoulder 23 of the driving shaft 2. When the movable terminal 1 is in the opened position, the auxiliary elastic member 4 is received in the space between the bottom of the movable terminal 1 and the shoulder 23 of the driving shaft 2.

In another exemplary embodiment of the present invention, a contactor is also disclosed. The contactor includes a housing, a static terminal 9, a coil, and the aforementioned contactor movable terminal assembly. The static terminal 9 is fixed into the housing. The coil is installed in the housing. The contactor movable terminal assembly is movably installed in the housing. When the coil is energized, the driving shaft 2 drives the movable terminal 1 from the open position to the closed position under the electromagnetic force generated by the coil.

In the aforementioned exemplary embodiments of the present invention, when the movable terminal 1 is in the closed position in electrical contact with the static terminal 9, both the main clastic member 3 and the auxiliary elastic member 4 simultaneously apply contact pressure to the movable terminal 1, reducing the contact resistance between the movable terminal 1 and the static terminal 9, improving the ability of the contactor to withstand short-circuit current, and the auxiliary elastic member 4 does not affect the normal suction of the contactor.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor movable terminal assembly, comprising:
a movable terminal;
a driving shaft movably connected to the movable terminal, the driving shaft drives the movable terminal from an opened position electrically separated from a static terminal to a closed position electrically in contact with the static terminal;
a main elastic member axially compressed between a bottom of the movable terminal and the driving shaft to provide a main contact pressure to the movable terminal; and
an auxiliary elastic member disposed between the movable terminal and the driving shaft, the auxiliary elastic member is axially compressed between the bottom of the movable terminal and the driving shaft to provide an auxiliary contact pressure to the movable terminal when the movable terminal is in the closed position, the auxiliary elastic member is not axially compressed when the movable terminal is in the opened position.

2. The contactor movable terminal assembly according to claim 1, wherein a flange portion is formed on the driving shaft and the auxiliary elastic member is axially supported on the flange portion, the main elastic member is axially compressed between the bottom of the movable terminal and the flange portion of the driving shaft.

3. The contactor movable terminal assembly according to claim 2, wherein the auxiliary elastic member includes a main body and a cantilever portion connected to the main body, the main body is axially supported on the flange portion, a pair of ends of the main elastic member are respectively pressed against the main body and the movable terminal, an end of the cantilever portion is against the bottom of the movable terminal when the movable terminal is in the closed position.

4. The contactor movable terminal assembly according to claim 3, wherein the main body includes a bottom wall and a side wall connected to the bottom wall, the cantilever portion is connected to an upper edge of the side wall and extends obliquely relative to the side wall, the bottom wall of the main body is against the flange portion of the driving shaft, and a lower end of the main elastic member is against the bottom wall of the main body.

5. The contactor movable terminal assembly according to claim 2, wherein an upper end of the driving shaft extends through the movable terminal, and a limiting member is installed on the upper end of the driving shaft, a snap slot is formed on an outer peripheral surface of the upper end of the driving shaft, the limiting member is a snap ring fitted in the snap slot of the driving shaft, the limiting member is axially pressed against a top of the movable terminal to limit a position of the movable terminal when the movable terminal is in the opened position, and the limiting member is separated from the movable terminal by a predetermined distance when the movable terminal is in the closed position.

6. The contactor movable terminal assembly according to claim 1, further comprising an insulator, an upper end of the driving shaft is fixed into the insulator, the main elastic member is axially compressed between the movable terminal and the insulator, the auxiliary elastic member is axially supported on the insulator, the auxiliary elastic member is axially compressed between the movable terminal and the insulator when the movable terminal is in the closed position.

7. The contactor movable terminal assembly according to claim 6, wherein the auxiliary elastic member includes a main body and a cantilever portion connected to the main body, the main body is axially supported on the insulator, a pair of ends of the main elastic member are respectively pressed against the insulator and the movable terminal, an end of the cantilever portion is against the bottom of the movable terminal when the movable terminal is in the closed position.

8. The contactor movable terminal assembly according to claim 7, wherein the main body has a bottom wall supported on a top surface of the insulator and a side wall connected to the bottom wall, the cantilever portion is connected to an upper edge of the side wall and extends obliquely relative to the side wall.

9. The contactor movable terminal assembly according to claim 8, wherein an opening is formed in the bottom wall of the main body and the main elastic member extends through the opening, a recess is formed on the insulator and accommodates the main elastic member, the main elastic member extends through the bottom wall of the main body, a lower end of the main elastic member is supported on a bottom surface of the recess of the insulator.

10. The contactor movable terminal assembly according to claim 6, wherein the main elastic member and the auxiliary elastic member are spiral springs, respectively, the auxiliary elastic member is disposed inside the main elastic member, a recess is formed on a top of the insulator and accommodates the main elastic member and the auxiliary elastic member, a pair of lower ends of the main elastic member and the auxiliary elastic member are supported on a bottom surface of the recess of the insulator.

11. The contactor movable terminal assembly according to claim 6, further comprising a limiting member including a top plate and a pair of side plates connected to the top plate, a pair of lower parts of the pair of side plates of the limiting member are fixed to the insulator, the movable terminal and the auxiliary elastic member are accommodated in the limiting member, the top plate of the limiting member is axially pressed against a top of the movable terminal to limit a position of the movable terminal when the movable terminal is in the opened position, the top plate of the limiting member is separated from the movable terminal by a predetermined distance when the movable terminal is in the closed position.

12. The contactor movable terminal assembly according to claim 11, wherein the insulator is an injection molded part directly molded onto the driving shaft and the limiting member through an embedded injection molding process, the driving shaft, the limiting member, and the insulator are formed into an integral piece.

13. A contactor movable terminal assembly, comprising:
a movable terminal;
a driving shaft movably connected to the movable terminal, the driving shaft drives the movable terminal from an opened position electrically separated from a static terminal to a closed position electrically in contact with the static terminal;
a main elastic member axially compressed between the movable terminal and the driving shaft to provide a main contact pressure to the movable terminal; and
an auxiliary elastic member disposed between a bottom of the movable terminal and a top of the main elastic member, the auxiliary elastic member is axially compressed between the bottom of the movable terminal and the driving shaft to provide an auxiliary contact pressure to the movable terminal when the movable terminal is in the closed position.

14. The contactor movable terminal assembly according to claim 13, wherein a shoulder is formed on the driving shaft, the shoulder supports a bottom of the auxiliary elastic member, the auxiliary elastic member is axially compressed between the bottom of the movable terminal and the shoulder of the driving shaft when the movable terminal is in the closed position, and the auxiliary elastic member does not contact the shoulder of the driving shaft and is axially spaced from the shoulder by a predetermined distance when the movable terminal is in the opened position.

15. The contactor movable terminal assembly according to claim 13, wherein the main elastic member is a spiral spring and the auxiliary elastic member is a disc spring, the auxiliary elastic member has a bottom opening and a top opening, a diameter of the top opening is larger than the bottom opening, an edge of the top opening of the auxiliary elastic member is against a bottom surface of the movable terminal, the bottom of the auxiliary elastic member is against a top of the main elastic member.

16. The contactor movable terminal assembly according to claim 13, wherein a flange portion is formed on the driving shaft, the main elastic member is axially compressed between the bottom of the auxiliary elastic member and the flange portion of the driving shaft.

17. The contactor movable terminal assembly according to claim 13, further comprising a washer supported on the flange portion of the driving shaft and having a diameter larger than a diameter of the flange portion, an upper end and a lower end of the main elastic member are respectively pressed against the bottom of the auxiliary elastic member and a top surface of the washer.

18. The contactor movable terminal assembly according to claim 13, wherein an upper end of the driving shaft extends through the movable terminal and a limiting member is installed on the upper end of the driving shaft, a snap slot is formed on an outer peripheral surface of the upper end of the driving shaft, the limiting member is a snap ring which is fitted in the snap slot of the driving shaft, the limiting member is axially pressed against a top of the movable terminal to limit a position of the movable terminal when the movable terminal is in the opened position, the limiting member is separated from the movable terminal by a predetermined distance when the movable terminal is in the closed position.

19. The contactor movable terminal assembly according to claim 13, wherein an elastic coefficient of the auxiliary elastic member is greater than an elastic coefficient of the main elastic member, an axial compression amount of the auxiliary elastic member is less than an axial compression amount of the main elastic member under a same axial pressure.

20. A contactor, comprising:
a housing;
a static terminal fixed to the housing;
a coil installed in the housing; and
a contactor movable terminal assembly movably arranged in the housing, the contactor movable terminal assembly includes:
a movable terminal;
a driving shaft movably connected to the movable terminal, the driving shaft drives the movable terminal from an opened position electrically separated from the static terminal to a closed position electrically in contact with the static terminal, the driving shaft drives the movable terminal from the opened position to the closed position under an electromagnetic force generated by the coil when the coil is energized;
a main elastic member axially compressed between a bottom of the movable terminal and the driving shaft to provide a main contact pressure to the movable terminal; and
an auxiliary elastic member disposed between the movable terminal and the driving shaft, the auxiliary elastic member is axially compressed between the bottom of the movable terminal and the driving shaft to provide an auxiliary contact pressure to the movable terminal when the movable terminal is in the closed position, the auxiliary elastic member is not axially compressed when the movable terminal is in the opened position.
